(19) United States
(12) Patent Application Publication
(10) Pub. No.: US 2010/0260270 A1
(43) Pub. Date: Oct. 14, 2010

(54) SYSTEM AND METHOD FOR ENCODING VIDEO

(75) Inventor: Anand Kapoor, Los Angeles, CA (US)

Correspondence Address: Robert D. Shedd, Patent Operations;THOMSON Licensing LLC, P.O. Box 5312, Princeton, NJ, 08543-5312, US

(73) Assignee: THOMSON LICENSING, PRINCETON, NJ (US)

(21) Appl. No.: 12/742,294

(22) PCT Filed: Nov. 12, 2008
(86) PCT No.: PCT/US08/12686

§ 371 Date: May 11, 2010

Related U.S. Application Data
(60) Provisional application No. 61/003,278, filed on Nov. 15, 2007.
(60) Provisional application No. 61/003,392, filed on Nov. 16, 2007.

(51) Int. Cl. H04N 7/26

(52) U.S. Cl. 375/240.27; 375/240.01; 375/E07.2

(57) ABSTRACT

A system and method for encoding video with versioning to allow for control, organization of scenes/shots and presentation of re-encoding history are provided. The system and method of the present disclosure provide for generating a first version of encoded video based on a first encoding parameter, generating at least one second version of encoded video based on a second re-encoding parameter, generating comparison data based on the first and the at least one second version for encoded video, and displaying the first and the at least one second version of encoded video and said comparison data. The comparison data is at least one of a listing of video artifacts, a video file size, encoding parameters and metadata generated from the first and the at least one second version of encoded video.

This application claims the benefit under 35 U.S.C.§119 of a provisional application 61/003278 filed in the United States on Nov. 15, 2007 and a provisional application 61/003392 filed in the United States on Nov. 16, 2007.

### TECHNICAL FIELD OF THE INVENTION

The present disclosure generally relates to computer graphics processing and display systems, and more particularly, to a system and method for encoding video with versioning.

### BACKGROUND OF THE INVENTION

In the past, tape-based standard definition video re-encoding has been a mechanical process, where a compressionist or a video quality engineer would verify the video quality of the source, encode or the re-encode (fixes) and requested video artifact fixes based on their visual findings. Referring to FIG. 1, a conventional tape workflow for encoding a video is illustrated. Generally, a tape is acquired containing a video 10. The tape is then loaded onto a tape drive 12 to be ingested by an encoding system. Various encoding/recoding parameters would be applied to the video 14 and the video would be encoded 16 resulting in a encoded file 18. The compressionist would essentially re-run the tape-based content through the available filtering, digital video noise-reducers, compression and other hardware/software, e.g., multiple iterations, 20 to get the desired re-encoded video output results 22. The multiple iterations of the re-encoding may be encoder driven re-encoding or QC (quality control) driven re-encoding. Encoder driven re-encodings are automatic (can also be manual) re-encodes based on some statistical analysis of bit-rate allocation, video quality/artifact, peak-signal-to-noise ratio, or any combination of these together. QC driven encoding are compressionist or video quality engineer driven re-encodings to improve the video quality that may have been missed by the above statistical analysis process due to highly random nature of the video content being encoded.

The compression codecs used during this time were simple and well understood. This was sufficient for standard definition disc formats as the volume of a video feature that was encoded was quite modest due to physical limitation of older optical storage media. Also, tape-based distribution (e.g., VHS tapes, DLT, etc) was the preferred means to ingest into different avenues of video for standard definition production as assets were fewer, manageable and served well for this particular production. However, this process was time consuming and prone to errors. Furthermore, the conventional tape workflow did not keep a history of fixes other than the last fix, and therefore, did not allow for comparison between versions of fixes.

With the advent of newer increased optical storage space media with supported advance codecs such as H.264 (AVC) and better compression ratio to video quality, it has become possible to make use of this additional disc space for other value added contents such as games, bonus video content, interviews, concerts, picture-in-picture, and events that client/consumers demand today. This has also essentially increased the sheer volume of high-definition video content, increased complexity (multiple systems, softwares, etc) and time necessary for successful encodes, heightened the need to better manage/understand the digital content and increased value added material, however, with a shorter turn around time to complete this additional content material. Using the old conventional standard definition production workflow would not be a viable proposition. This has required moving the high definition production toward tapeless distribution to make this process more cost effective as that would require less physical assets (D5 tapes, DLTs, etc) to keep track and store and make it easier to manipulate/work digitally.

Therefore, a need exists for techniques to overcome the disadvantages of the conventional tapeless digital workflow and better manage the re-encoding process that increases efficiency for the compressionist by enabling reusability of their learning, allowing application of multiple re-encoding properties/tools, and affording ease of use and control.

### SUMMARY

A system and method for encoding video are provided. The system and method of the present disclosure provides for re-encoding with versioning to allow for control, organization of scenes/shots and presentation of re-encoding history during the re-encoding process all of which is necessary during all quality improvement re-encoding work. The system and method of the present disclosure reduces the time required to accomplish multiple re-encoding while building a library of solutions, provides and promotes reusability across multiple encoding jobs.

According to one aspect of the present disclosure, a method for encoding video is providing, the method including the steps of generating a first version of encoded video based on a first encoding parameter, generating a second version of encoded video based on a second encoding parameter, generating comparison data based on said first and second version for said encoded video, and displaying said first and second version of encoded video and said comparison data. The comparison data is at least one of a listing of video artifacts, a video file size and encoding parameters.

According to another aspect of the present disclosure, a system for encoding video is provided including an encoder for generating a first version of encoded video based on a first encoding parameter and at least one second version of encoded video based on a second re-encoding parameter, a comparator for generating comparison data based on said first and said at least one second version for encoded video, and a user interface for displaying said first and said at least one second version of encoded video and said comparison data.

According to a further aspect of the present disclosure, a program storage device readable by a machine, tangibly embodying a program of instructions executable by the machine to perform method steps for encoding video is provided, the method including generating a first version of encoded video based on a first encoding parameter, generating at least one second version of encoded video based on a second re-encoding parameter, generating comparison data based on said first and said at least one second version for encoded video, and displaying said first and said at least one second version of encoded video and said comparison data.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 illustrates a workflow for encoding video from tape according to the prior art;

FIG. 2 illustrates a tapeless workflow for encoding video according to an aspect of the present disclosure;

FIG. 3 is an exemplary illustration of a system for encoding video according to an aspect of the present disclosure;

FIG. 4 is a flow diagram of an exemplary method for encoding video according to an aspect of the present disclosure;

FIG. 5 illustrates an exemplary screen shot for selecting a shot/scene of a video to be re-coded according to an aspect of the present disclosure;

FIG. 6 illustrates another exemplary screen shot for selecting a shot/scene of a video to be re-coded according to another aspect of the present disclosure; and

FIGS. 7-10 illustrate several exemplary screen shots for controlling the re-encoding of the video, controlling the versioning of re-encoding of the video, and for applying at least one re-encoding parameter to the video according to an aspect of the present disclosure.

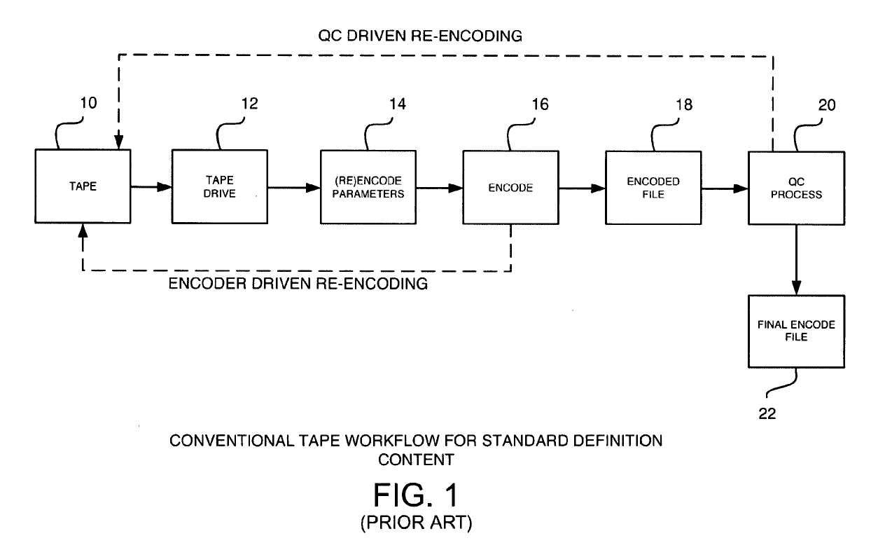

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

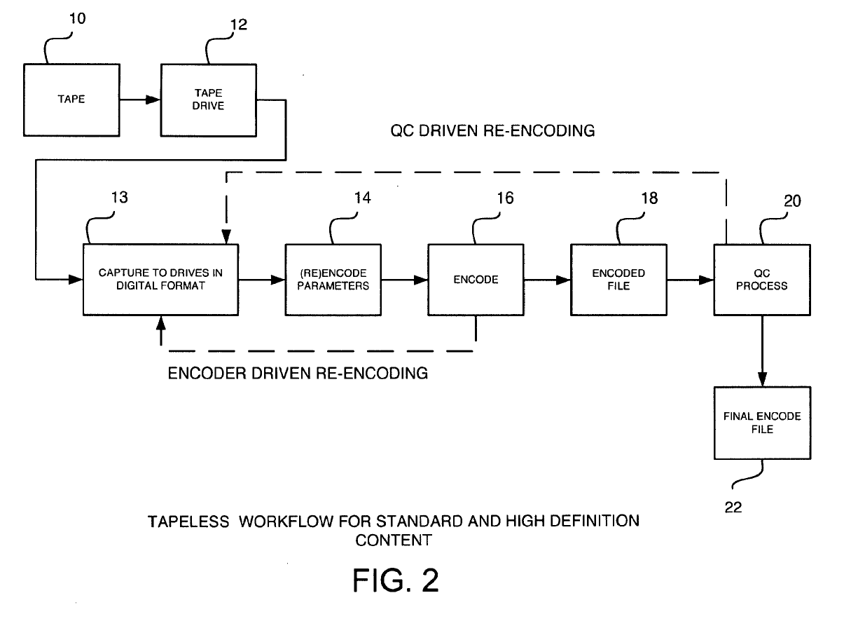

A system and method for encoding video are provided. The system and method of the present disclosure provides for re-encoding with versioning to allow for control, organization of scenes/shots and presentation of re-encoding history during the re-encoding process all of which is necessary during all quality improvement re-encoding work. Referring to FIG. 2, a tapeless workflow for encoding a video in accordance with the present disclosure is illustrated. In the workflow of FIG. 2, a video tape is played via a tape drive and is captured and converted to digital format 13. After the content is captured and converted to digital format, it becomes easy to deal with in a complete digital workflow (e.g., on a computer). All the image filters are either software driven or performed with specialized hardware acceleration. This allows a compressionist or video quality engineer to easily apply the fixes to the video content using dedicated software or hardware. As will be described below, the system of the present disclosure will have dedicated software and/or hardware to allow a user, e.g., a compressionist or video quality engineer, to select particular shot/scene(s) or particular in/out frames for re-encoding; allow a user to specify the re-encoding parameters applied; and allow playback of the content using an integrated video player. The system and method will allow for multiple iterations of re-encoding and making granular improvements possible. The system and method of the present disclosure may save every iteration and compile a history of fixes thus allowing comparison between multiple re-encoding (fixes), encoding and its source. Furthermore, the system and method includes a library of preset fixes to considerably reduce the time to carry out the fixes.

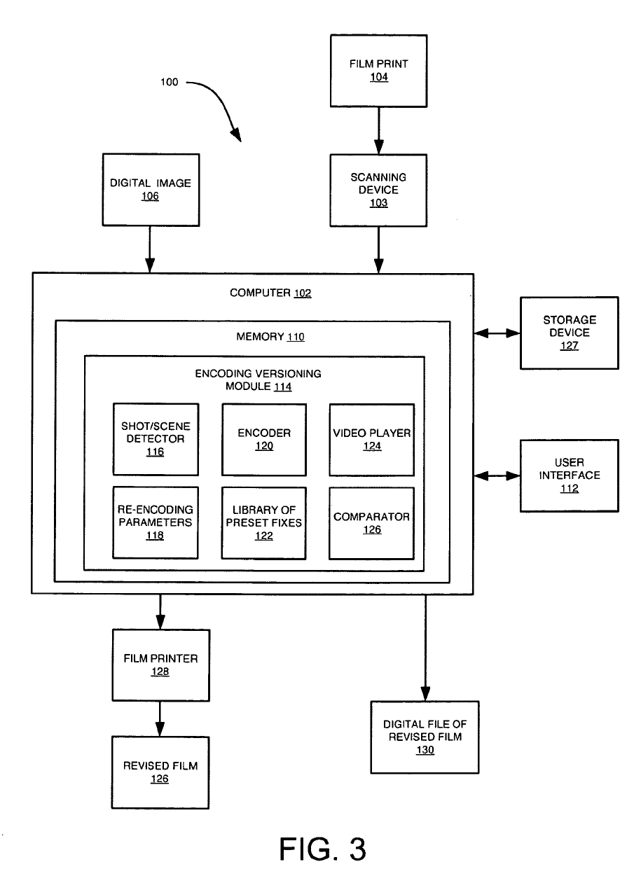

Referring now to the Figures, an exemplary system 100 according to an embodiment of the present disclosure is shown in FIG. 3. A scanning device 103 may be provided for scanning film prints 104, e.g., camera-original film negatives, into a digital format, e.g. Cineon-format or SMPTE DPX files. The scanning device 103 may comprise, e.g., a telecine or any device that will generate a video output from film such as, e.g., an Arri LocPro™ with video output. Alternatively, files from the post production process or digital cinema 106 (e.g., files already in computer-readable form) can be used directly. Potential sources of computer-readable files are AVID™ editors, DPX files, D5 tapes etc.

Scanned film prints are input to a post-processing device 102, e.g., a computer. The computer is implemented on any of the various known computer platforms having hardware such as one or more central processing units (CPU), memory 110 such as random access memory (RAM) and/or read only memory (ROM) and input/output (I/O) user interface(s) 112 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as post-processing device 102. In addition, various other peripheral devices may be connected to the computer platform by various interfaces and bus structures, such a parallel port, serial port or universal serial bus (USB). Other peripheral devices may include additional storage devices 127 and a printer 128. The printer 128 may be employed for printing a revised version of the film 126, e.g., a re-encoded version of the film, wherein a scene or a plurality of scenes may have been altered or fixed as a result of the techniques described below.

Alternatively, files/film prints already in computer-readable form 106 (e.g., digital cinema, which for example, may be stored on external hard drive 127) may be directly input into the computer 102. Note that the term “film” used herein may refer to either film prints or digital cinema.

A software program includes an encoding versioning module 114 stored in the memory 110 for encoding/re-encoding video. The encoding versioning module 114 will include various modules that interact to perform the various functions and features provided in the present disclosure. The encoding versioning module 114 can includes a shot/scene detector 116 configured to determine at least one shot or scene of a video, e.g., a film or movie. The encoding module 114 further includes an re-encoding parameters 118 configured for selecting and applying encoding/re-coding parameters to the detected shot/scene(s). Exemplary re-encoding parameters include DeltaRate to change the bitrate of the particular shot/scene, a Deblocking Filter to remove blocking artifacts from the shot/scene, etc.. An encoder 120 is provided for encoding the ingested video into at least one digital format. Exemplary encoders include MPEG-4 (H.264), MPEG-2, QuickTime, etc. The encoding versioning module 114 will assign a version number or indication to each version of the video that is encoded.

A library of preset fixes 122 is provided for applying at least one or more fixes to a video shot or scene based on a given condition. The library of preset fixes 122 is a collection of re-encoding parameters to resolve certain artifacts. A user can apply a certain preset by first selecting a shot/scene and then selecting an existing already created preset based on an artifact found in the shot/scene. Presets can also be applied on a user created category basis. Moreover, these presets would be saved for later use across similar video encoding projects when necessary.

The encoding versioning module 114 further includes a video player 124 for decoding the video shot/scene and visualizing the video to a user. A comparator 126 is provided for comparing data of at least two videos of the same shot/scenes and for displaying the comparison data to a user.

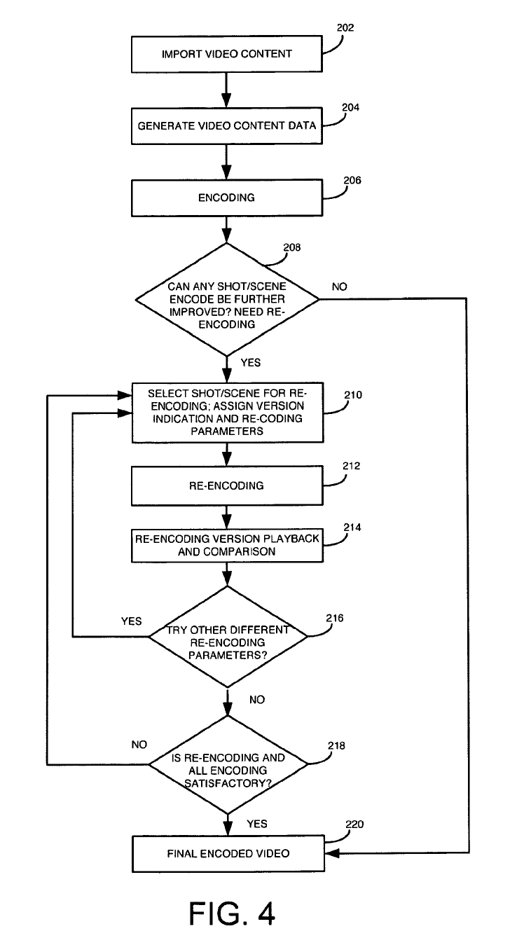

FIG. 4 is a flow diagram of an exemplary method for encoding video according to an aspect of the present disclosure. Initially, the post-processing device 102 acquires or imports video content (step 202). The post-processing device 102 may acquire the video content by obtaining the digital master image file in a computer-readable format. The digital video file may be acquired by capturing a temporal sequence of moving images with a digital camera. Alternatively, the video sequence may be captured by a conventional film-type camera. In this scenario, the film is scanned via scanning device 103.

It is to be appreciated that whether the film is scanned or already in digital format, the digital file of the film will include indications or information on locations of the frames, e.g., a frame number, time from start of the film, etc.. Each frame of the digital image file will include one image, e.g., I₁, I₂, . . . Iₙ.

After the video is imported, the video is ingested and video content data is generated (step 204). This step is introduced to prepare the video data coming from different sources into an encoder acceptable format, e.g., from a 10-bit DPX format to an 8-bit YUV format. This may require to drop the bit depth of the images as necessary, save additional color metadata information that could be used within the encoding process, etc. From the ingested video, several algorithms or functions are applied to the video to derive content data, e.g., metadata. For example, scene/shot detection algorithms are applied via the shot/scene detector 116 to segment the complete video into scene/shots; fade/dissolve detection algorithms may also be used. Further content data generated includes histograms, classification based on colors, similar scene detection, bit rate, frame-classification, thumbnails, etc..

Next, in step 206, the video is encoded by encoder 12. The first encode makes the Version 0 or the base/reference encode version. All the other versions will be compared to this version for video quality improvements as necessary or between a version of a respective shot/scene.

In step 208, it is determined whether any shot/scene encode can be further improved or needs recoding. The quality of the video shot/scenes can be improved automatically during the first encode. A compressionist can visually inspect the shot/scene to determine if further re-encoding is necessary. If it is determined, no further re-encoding is necessary, the final encoded video will be output at step 220. Otherwise, if further re-encoding is necessary, the method will continue to step 210 either by applying presets or individual re-encoding parameter.

In step 210, a shot/scene will be selected by a user, automatically assigned a version number or indication and new re-encoding parameters will be assigned or selected from a list of re-encoding parameters 118. Alternatively, a user or compressionist may select from a library of preset fixes 122 which may include one or more re-coding parameters. It is to be appreciated that the user may select a frame or frames with a shot/scene for the re-encoding process.

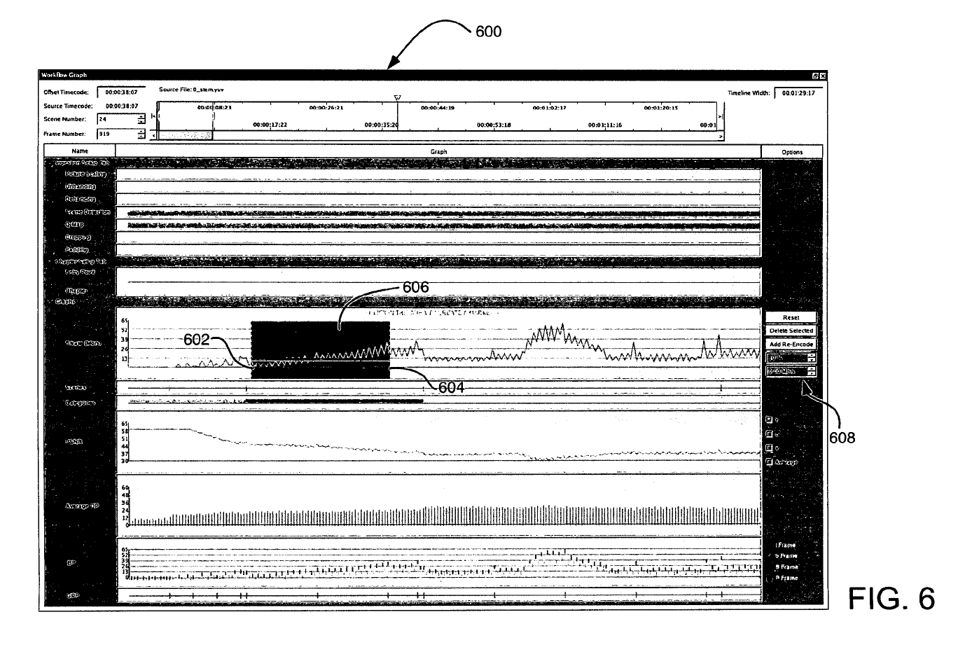

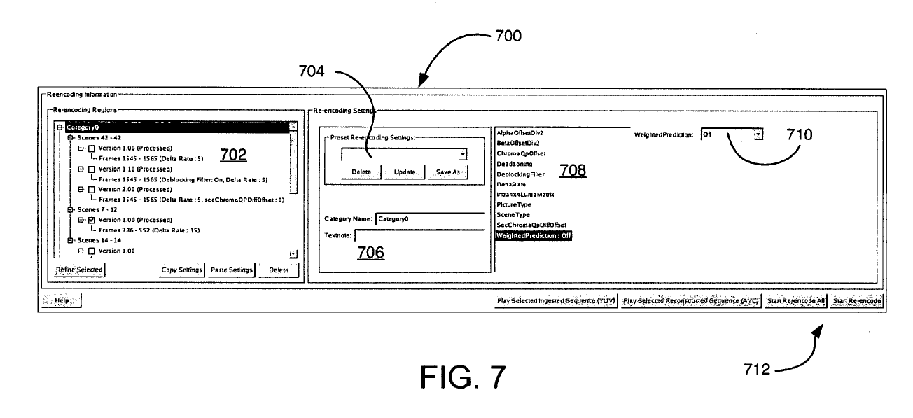

Re-encoding on the selected shot/scene is then performed (step 212) and the re-encoded version is then played back via video player 124 and compared to previous versions of the selected shot/scene(s) (step 214) via comparator 126 for verifying video or re-encoding quality. In one embodiment, the re-encoded version and the previous version will be visually compared by displaying these videos in a split screen via the video player 124. Comparison data (or metadata) such as average bit-rate levels, encode frame types, peak-signal-to-noise ratios, etc. could also be compared simply by selecting/checking the particular version and visually differentiating data for that shot/scene versions, as will be described below in relation to FIGS. 6 and 7. At all times one version of each shot/scene is selected for continuity. Other comparison data may be displayed such as a listing of video artifacts detected in the encoded and re-encoded version of video, a video file size and the particular encoding parameters employed for a selected version.

After the re-encoding is performed based on the re-encoding parameters selected in step 210, it is determined if the re-encoding for the shot/scene is satisfactory or if other different re-encoding parameters should be applied (step 216). This determination is a visual/manual process using split video or visuallizing the comparison data. In one embodiment, the user or compressionist will select one of several generated versions that is relatively free of artifacts as a final version of the encoded video based on visualization of the comparison data, e.g., the peak-signal-to-noise ratio. In other embodiment, the user or compressionist will select one of the several generated versions that is relatively free of artifacts as a final version of the encoded video based on a split visualization of at least two selected versions by the video player 124. If the re-encoding for the shot/scene is not satisfactory, the process will revert back to step 210 and other re-encoding parameters will be applied. Otherwise, the process will go to step 218.

In step 218, it is then determined if the encoding and re-encoding is satisfactory for all the shot/scenes associated with a complete video clip or movie. If there are further shot/scenes to be re-encoding, the process will revert to step 210 and another shot/scene will be selected. Otherwise, if the encoding and re-encoding is satisfactory for all shot/scenes, the final encoded video is stored, e.g., in storage device 127, and may be retrieved for playback (step 220). Furthermore, shots/scenes of a motion picture or video clip can be stored in a single digital file 130 representing a complete version of the motion picture or clip. The digital file 130 may be stored in storage device 127 for later retrieval, e.g., to print a tape or film version of the encoded video.

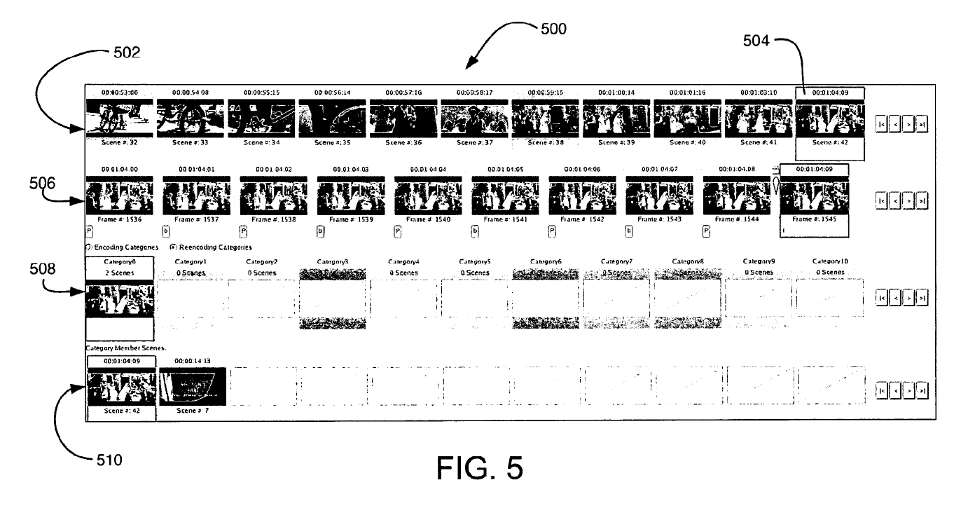

FIGS. 5-10 illustrate several exemplary screen shots for controlling the re-encoding of the video and for applying at least one re-encoding parameter to the video according to an aspect of the present disclosure.

Referring to FIG. 5, a first representation to select particular shot/scene(s) for re-encoding is illustrated. An interface 500 is provided that shows part of a thumbnail representation of the entire feature with shot/scene detection already performed on it. The thumbnails can be selected to mark-in (e.g., the beginning) and mark-out (e.g., the end) regions for re-encoding. These selections can be performed at scene level or frame level and determine the particular region for re-encoding. In FIG. 5, the detected shot/scenes of the video are represented by thumbnails 502. Upon selecting a particular shot/scene thumbnail 504, the frames associated with the selected shot/scene are displayed as thumbnails 506 to the user.

The interface 500 includes a section 508 for adding shots for re-encoding by drag and drop into a re-encoding category or using a context menu by clicking on the thumbnails themselves. The scenes 502 can simply be dropped within the user defined colored categories 508. In one embodiment, the colors of the category will signify video artifacts, complexity, shot/scene flashes, etc. The interface 500 also includes a section 510 which shows the individual scene(s) belonging in the above selected category 508. These thumbnails show the first frame of the shot/scenes that belong within the selected/highlighted category.

Referring to FIG. 6, a second representation to select particular shot/scene(s) at a frame level for re-encoding is illustrated. Another interface 600 is provided that represents additional properties or metadata of the (re)encoded video stream. For example, a bit rate graph could be used to mark-in and mark-out the region that requires quality enhancement based on encoded stream properties. Here, mark-in/mark-out is represented by flags 602, 604 and a shaded area 606. Section 608 is provided for applying additional parameters for re-encoding before adding for re-encoding.

FIGS. 7-10 illustrate several exemplary screen shots for enabling a compressionist or video quality engineer to control the re-encoding of the video and to apply at least one re-encoding parameter to the video and to allow the compressionist or video quality engineer to pick a version of a re-encoding that is relatively free of video artifacts according to an aspect of the present disclosure. According to various aspects of the present disclosure, the compressionist or video quality engineer can provide multiple additional re-encoding parameters being applied at a more granule level down to individual frames within same scene.

FIG. 7 shows an interface 700 for selecting additional re-encoding setup properties at the category level. Section 702 shows a tree like list containing re-encoding regions requested by the user using the above selection components, e.g., a shot/scene or frame as described in relation to FIGS. 5 and 6. The tree includes: 1.) Categories—grouping that re-encoding scene is part, i.e., it allows similar re-encoding property to be applied to all scenes that are part of it; 2.) range of scenes numbers—includes the start and end scenes that re-encoding is part; 3.) version—the version of re-encoding being performed with progress status information (the check box provides a way to select the version that compressionist seems fit or resolves all the video artifact); and 4.) frame range—where the re-encoding properties are being applied. In this manner, the user interface 700 will display a history of versions indication for a shot/scene or frames. Section 704 shows a list of presets that are developed over time to resolve common re-encoding issues, e.g., the library of preset fixes 122. These presets serve as a re-encoding toolkit that could be used or shared with other compressionist/users to expedite issues. Section 706 illustrates the category name which could be assigned and additional textual data that could be associated with the Category to make better sense of the purpose that the category serves. Section 708 illustrates a list of re-encoding parameter names that could be applied to resolve the video artifacts. The filters or re-encoding parameters shown in section 708 belong to the preset selected in section 704 and the list will change as different presets are selected. Section 710 is where the user would select the strength of the re-encoding parameter being applied. Section 712 includes buttons to start selected re-encoding or start all for re-encoding that have not been done so far.

Using the interfaces 600, 700 of FIGS. 6 and 7, re-encoding on the shot/scene selected in section 702 is then performed (as described in step 212 above) and the re-encoded version is then played back via video player 124 and compared to previous versions of the selected shot/scene(s) (as described in step 214 above) via comparator 126 for verifying video or re-encoding quality. In one embodiment, the re-encoded version and the previous version will be visually compared by displaying these videos in a split screen via the video player 124. In a further embodiment, comparison data (also known as metadata) such as average bit-rate levels, encode frame types, peak-signal-to-noise ratios (PSNRs), etc could also be compared simply by selecting/checking the particular version 702 and visually differentiating data in the shaded section 606 of FIG. 6 for that shot/scene versions, where the interface 600 would act as comparator 126. Here, by selecting between versions of video, the interface 600 will toggle between the metadata for each version for visual inspection by a user or compressionist. For example, a user could toggle between two different versions of the video to observe the PSNR data for each video where the higher the PSNR the better the video quality.

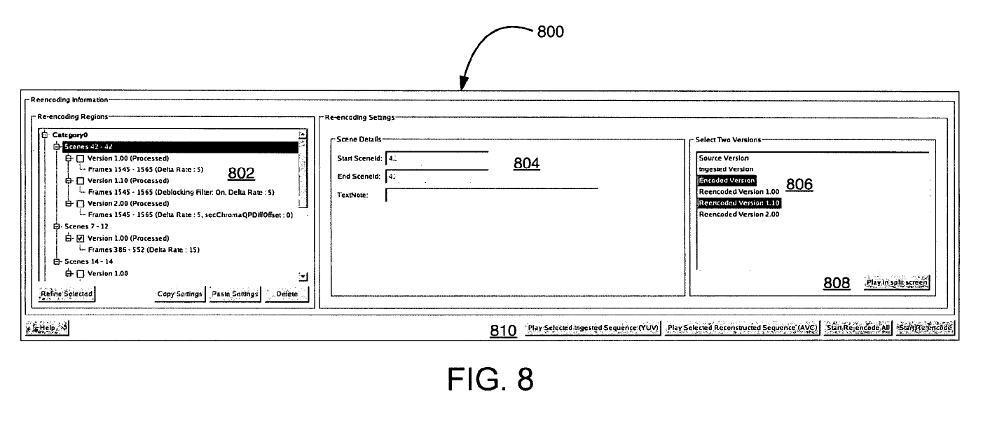

FIG. 8 shows an interface 800 for selecting additional re-encoding setup properties at the scene level. In section 802, the scene level node is selected. It shows the scene number for the scene that is being re-encoded. Section 804 illustrates the region to associate textual data regarding the scene being re-encoded. Section 806 provides a list of all the options to select and compare between different phases or versions of the particular scene. This list includes:

Source Version—This is the actual source of the scene

Ingested Version—This is the ingested version of the scene

Encoded Version—This is the first encoded version of the scene

Re-encode Version X.YY—These are the re-encodes requested by the compressionist. X.YY shows the generation and history of the re-encodes. X is the major version whereas YY shows the minor version. Using the X.YY version indication, the user can figure out the progression of re-encodes. For example, one representation of the versioning mythology could be as follows:

Version 1.00—first attempt of re-encoding with certain re-encoding parameter(s).

Version 1.10—second attempt of re-encoding with above parameters with some additional or further refinements. Version 1.00 being the parent, providing the actual set of parameters to begin re-encode.

Version 1.11—attempt to further refine Version 1.10 with some additional parameters.

Version 2.00—fresh attempt of re-encoding with different set of re-encoding parameter(s).

Above example also show how the user can deduce the progression of re-encoding that follows to improve the quality of encodes. This allows a user to better understand the re-encoding process and narrow down to quality encodes quickly by trying out different sets of re-encoding for the same scene simultaneously, thereby, improving compressionist productivity and improving quality. Selecting any two of the versions would allow the compressionist to compare the re-encoded version together using a split-screen integrated video player 124. This way quality improvements between versions can be easily spotted and selected thus improving the final encoded video stream.

Referring back to FIG. 8, section 808 provides a button that launches the video player in split-screen mode comparing the two-version selected in Section 806. Buttons provided in section 810 launches the video player in full-screen mode playing either the selected scene's ingested or the re-encoded video stream.

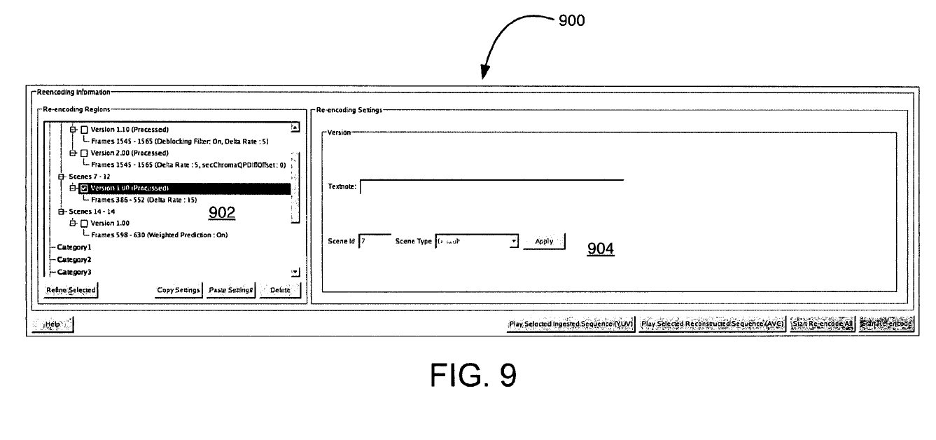

FIG. 9 illustrates an interface 900 for selecting additional re-encoding setup properties at the version level. Section 902 provides a list of the version for various shot/scenes, e.g., Version X.YY. These are the re-encodes requested by the compressionist. X.YY shows the generation and history of the re-encodes. X is the major version whereas YY shows the minor version. Using the X.YY, the user can figure out the progression of re-encodes. Section 904 of FIG. 9 allows a user to associate additional textual data with the version selected.

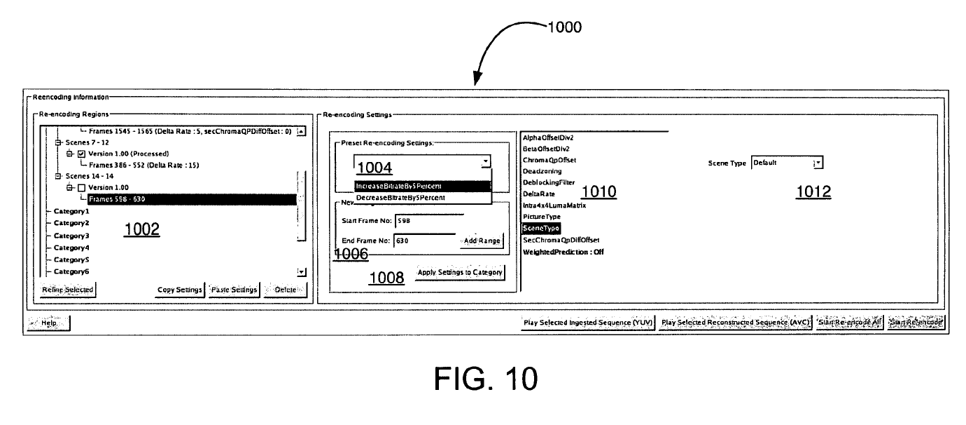

FIG. 10 shows an interface 1000 for selecting additional re-encoding setup properties at the frame range level. Section 1002 shows the frame numbers that would be re-encoded with the particular scene selected. This selection is determined using one of the above representation of selecting shot/scene(s) for re-encoding as described in relation to FIGS. 5 and 6. Section 1004 shows a list of preset(s) that are developed overtime and can be used to apply to frames to resolve common re-encoding artifacts, e.g., the library of preset fixes 122. These presets can be shared with other users. Section 1006 allows a user to add additional frame ravages. This enables the compressionist to customize and apply different re-encoding parameters to certain frames within the original selected range selection. Section 1008 enables a user to apply (copy) the present selected set of re-encoding parameters to a Category level. This way a compressionist can easily apply a tested version of fixes to the entire category of similar problem shots/scenes. Section 1010 provides a list of re-encoding parameters that can be applied to the frame range level and Section 1012 enables a compressionist to select a scene type. A compressionist can select or alter the strength of the re-encoding parameters.

A system and method for re-encoding video with versioning has been described. The system and method is simple and intuitive to implement and understand; improves and increases control over the encoding and re-encoding process and allows incremental video quality improvements/enhancements, insight and provides history regarding the re-encoding fixes. Furthermore, the system and method allows a user to save and develop library/knowledgebase overtime, and enables reusability across multiple encoding jobs or with other users for quick throughput; and provides an understanding of the effects of digital workflow/tools processes better (ingestion, filtering, encoding, or, re-encoding), and of comparing and troubleshooting quality issues/artifacts within compressed video outputs. Additionally, the system and method of the present disclosure reduces user/man-hours required to complete a fixed feature encoding and results in increased productivity and throughput.

Although embodiments which incorporate the teachings of the present disclosure have been shown and described in detail herein, those skilled in the art can readily devise many other varied embodiments that still incorporate these teachings. Having described preferred embodiments for a system and method for encoding video (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for encoding video, the method comprising the steps of:
generating a first version of encoded video based on a first encoding parameter;
generating at least one second version of encoded video based on a second re-encoding parameter;
generating comparison data based on said first and said at least one second version for encoded video; and
displaying said first and said at least one second version of encoded video and said comparison data.

2. The method of claim 1, wherein said comparison data is at least one of a listing of video artifacts, a video file size, encoding parameters and metadata generated from said first and said at least one second version of encoded video.

3. The method of claim 2, wherein the generated metadata is at least one of average bitrate, video frame structure and peak-signal-to-noise ratio.

4. The method of claim 1, wherein said first and said at least one second version for encoded video is at least one of a scene and a frame.

5. The method of claim 1, further comprising selecting one of said at least one second version that is relatively free of artifacts as a final version of the encoded video based on visualization of said comparison data.

6. The method of claim 1, further comprising selecting one of said at least one second version that is relatively free of artifacts as a final version of the encoded video based on a split visualization of said first and said at least one second version of encoded video.

7. The method of claim 1, wherein generating at least one second version of encoded video includes assigning a version indication for each of said at least one second version.

8. The method of claim 7, further comprising displaying a history of said version indications.

9. The method of claim 1, wherein generating at least one second version of encoded video includes applying at least two re-encoding parameters based on a predetermined video artifact.

10. A system for encoding video comprising:
an encoder for generating a first version of encoded video based on a first encoding parameter and at least one second version of encoded video based on a second re-encoding parameter;
a comparator for generating comparison data based on said first and said at least one second version for encoded video; and
a user interface for displaying said first and said at least one second version of encoded video and said comparison data.

11. The system of claim 10, wherein said comparison data is at least one of a listing of video artifacts, a video file size, encoding parameters and metadata generated from said first and said at least one second version of encoded video.

12. The system of claim 11, wherein the generated metadata is at least one of average bitrate, video frame structure and peak-signal-to-noise ratio.

13. The system of claim 10, wherein said first and said at least one second version for encoded video is at least one of a scene and a frame.

14. The system of claim 10, wherein the comparator is configured for generating a visualization of said comparison data, wherein the user interface is configured for selecting one of said at least one second version that is relatively free of artifacts as a final version of the encoded video based on visualization of said comparison data.

15. The system of claim 10, further comprising a video player for displaying a split visualization of said first and said at least one second version of encoded video, wherein the user interface is configured for selecting one of said at least one second version that is relatively free of artifacts as a final version of the encoded video based on the split visualization of said first and said at least one second version of encoded video.

16. The system of claim 10, further comprising a encoding versioning module for assigning a version indication for each of said at least one second version.

17. The system of claim 16, wherein the user interface is configured for displaying a history of said version indications.

18. The system of claim 10, further comprising a plurality of predetermined encoding fixes, each of the plurality of predetermined encoding fixes including at least one re-encoding parameter, wherein the encoder is configured to applying at least one of the plurality of predetermined encoding fixes based on a predetermined artifact.

19. A program storage device readable by a machine, tangibly embodying a program of instructions executable by the machine to perform method steps for encoding video, the method comprising:
generating a first version of encoded video based on a first encoding parameter;
generating at least one second version of encoded video based on a second re-encoding parameter;
generating comparison data based on said first and said at least one second version for encoded video; and
displaying said first and said at least one second version of encoded video and said comparison data.

20. The program storage device as in claim 19, wherein said comparison data is at least one of a listing of video artifacts, a video file size, encoding parameters and metadata generated from said first and said at least one second version of encoded video.
